(19) United States
(12) Patent Application Publication
(10) Pub. No.: US 2015/0239663 A1
(43) Pub. Date: Aug. 27, 2015

(54) METHODS AND SYSTEMS FOR A NOVEL WASTE BASKET

(71) Applicant: Michael T. Diep, Fountain Valley, CA (US)

(72) Inventor: Michael T. Diep, Fountain Valley, CA (US)

(21) Appl. No.: 14/628,204

(22) Filed: Feb. 20, 2015

Related U.S. Application Data
(60) Provisional application No. 61/943,185, filed on Feb. 21, 2014.

(51) Int. Cl. B65F 1/00; B65F 1/06; B65D 33/00; B65F 1/16

(52) U.S. Cl. CPC B65F 1/0013; B65F 1/16; B65F 1/062; B65D 33/002

(57) ABSTRACT

A waste basket system for convenient storage of waste basket trash bags close to a point of use features a waste basket with an inner ledge located on a waste basket side wall inner surface thereon offset from and parallel to a waste basket bottom. The system features a generally planar waste basket false floor having an aperture located therein. A raised aperture wall is located on a waste basket false floor top surface and surrounds the aperture. A raised lip surrounds a waste basket false floor outer periphery. The waste basket false floor is placed on the inner ledge. The system features a pliable waste basket trash bag located on an inside of the waste basket that wraps over a waste basket top terminating lip. The waste basket trash bag covers the waste basket side wall inner surface and the waste basket false floor top surface.

### CROSS-REFERENCE TO RELATED APPLICATION

This application claims the benefit of priority under 35 U.S.C. 119(e) to the filing date of U.S. provisional patent application No. 61/943,185 “Novel Waste Basket System” which was filed on Feb. 21, 2014, and which is incorporated herein by reference in it entirety.

### FIELD OF THE INVENTION

The present invention relates to trash cans or waste baskets for convenient dispensing and positioning empty trash bags within a trash container. More particularly, the invention relates to a trash can with a base portion design to store a plurality of trash bags, a body portion designed to store a single trash bag full of trash in such a way as to allow the full bag to be easily removed from the body portion, and a lid portion that seals the body portion closed.

### BACKGROUND OF THE INVENTION

Waste baskets or trash cans are commonly used in a variety of locations around a typical home or office. However, there are numerous problems associated with standard household waste baskets that have made trash storage and removal a dreaded task.

Often, a trash bag or trash bag is used inside the trash can or basket to keep the inside clean, but the bags are stored in a separate location away from the can or basket. Once the full bag of trash has been removed from the waste basket, the user must also locate a new bag to put in the waste basket. Still further, a user rarely realizes that all bags in the storage container have been used until the last remaining trash bag is filled and discarded. Therefore, until a new package of bags is purchased, the trash must be placed in an unlined can.

Another frustrating task is attempting to remove a full bag from the waste basket. This is often rather difficult because the trash stored in the bag tends to bulge against the walls of the waste basket, thus making it difficult to remove. In addition, as the bag is filled up, air is often trapped between the bag and the waste basket walls. This causes a vacuum effect that makes it even more difficult to remove the full bag. Because a full bag is so difficult to remove, when the bag is pulled straight upward, the entire waste basket often lifts up with the bag rather than the bag lifting out of the waste basket. Therefore, the user must often call on the assistance of another person to hold the waste basket steady, or else the user must squeeze the waste basket between the knees while pulling the bag out.

Another problem with conventional style waste baskets is that they do not force trash to be compacted within the waste basket. Therefore, when the full bag is removed, the user must attempt to shake the trash further down into the bag and compact it so that the bag may be tied shut.

Unfortunately, even properly positioning a new bag within conventional trash bags is often difficult because the walls of the empty bag tend to cling together in the center of the waste basket rather than fitting against the walls and bottom of the waste basket. This is especially undesirable as the bag begins to be filled, as air becomes trapped between the wall of the container and the bag. This prevents the bag from being completely filled, and makes it difficult to remove the bag from the waste basket once it is filled with trash. Accordingly, techniques for making changing bags in trash cans easier and less time consuming are desirable.

The present invention features a waste basket system for convenient storage of waste basket trash bags close to a point of use. The trash bag refill drawer minimizes time consumed in obtaining and replacing trash bags, and promotes complete and efficient use of trash bags. Importantly, the trash bag container must be easily and completely removable from the trash container to facilitate intermittent cleaning in the event of trash bag breakage. Removal also facilitates replacement of bags within the trash bag refill drawer. Finally, the trash bag drawer should be sufficiently substantial so that it will not collapse when it bears the weight of a heavily loaded bag of trash.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### OBJECT OF THE INVENTION

Accordingly, it is an object of the present invention to provide a waste basket with a removably attached trash bag refill drawer wherein the trash bag drawer can be easily and completely detached from the trash can.

It is also the object of the present invention to provide a waste basket with a trash bag refill drawer wherein the user can easily clean the trash container or the replace the trash bags within the trash container when the trash bags therein have all been dispensed.

It is also the object of the present invention to provide a waste basket that stores trash bags within the trash bag so that a new trash bag is readily accessible each time a full bag is removed from the trash can.

It is also the object of the present invention to provide a waste basket with an automatic trash bag refill system wherein when the full trash bag is removed from the waste basket, the full trash bag pulls on the next trash bag from the trash bag refill drawer, thereby the next trash bag is automatically retrieved and ready to use.

It is also the object of the present invention to provide a trash can with a trash bag drawer that allows for the store of a large quality of trash bags, thus minimizing the need to locate trash bags from another location when replacing a full trash bag.

It is also the object of the present invention to provide a trash can with a trash bad drawer which can be conveniently detached, refilled with trash bags, and re-attached to the trash can as needed.

It is also the object of the present invention to provide a trash can with a trash bag drawer that is sufficiently substantial that it will not collapse when it bears the weight of the heavily loaded bag of trash.

It is also the object of the present invention to provide a trash can from which it is extremely easy to remove a full bag. This is accomplished by placing ventilating slots in the base portion of the trash can to prevent air from being trapped between the bag and the body's walls and creating a vacuum. Alternatively, the ventilating slots can also be placed in the body portion of the trash can to eliminate the vacuum.

It is also the object of the present invention provide a configuration that actually forces trash to naturally compact as it is placed in the bag because when trash is placed into the bag, any air between the bag and the waste basket walls is forced out of the waste basket through the ventilation slots, thus compacting the trash and giving the bag more area to expand within the body portion.

It is also the object of the present invention to provide an affordable and efficient trash can and trash bag system, wherein the various types of trash bags can be used in combination with the trash bag refills drawer and the trash can itself.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### SUMMARY OF THE INVENTION

The present invention features a waste basket system for convenient storage of waste basket liners close to a point of use. In some embodiments, the system comprises a waste basket. In some embodiments, an inner ledge is located on a waste basket side wall inner surface thereon offset from and parallel to a waste basket bottom.

In some embodiments, the system comprises a generally planar waste basket false floor having an aperture located therein. In some embodiments, a raised aperture wall is located on a waste basket false floor top surface and surrounds the aperture. In some embodiments, a raised lip surrounds a waste basket false floor outer periphery. In some embodiments, the waste basket false floor is placed on the inner ledge located on the waste basket side wall inner surface.

In some embodiments, the system comprises a pliable waste basket liner. In some embodiments, the waste basket liner is a bag. In some embodiments, the liner is located on an inside of the waste basket. In some embodiments, the liner top wraps over a waste basket top terminating lip. In some embodiments, the waste basket liner covers the waste basket side wall inner surface and the waste basket false floor top surface.

In one embodiment, a waste basket system for convenient internal storage of waste basket liners proximal to a point of use, wherein the system comprises: (a) a waste basket having an open waste basket top, a planar waste basket bottom having a waste basket bottom inner surface, and a waste basket side wall having a waste basket side wall inner surface, wherein an inner ledge is disposed on the waste basket side wall inner surface thereon offset from and parallel to the waste basket bottom; (b) a generally planar waste basket false floor having an aperture disposed therein, wherein a raised aperture wall is disposed on a waste basket false floor top surface and surrounds the aperture, wherein a raised lip surrounds a waste basket false floor outer periphery, wherein the raised aperture wall and the raised lip both project out and away from the waste basket false floor top surface, wherein the waste basket false floor is removably disposed on the inner ledge disposed on the waste basket side wall inner surface; and (c) a pliable waste basket liner having an open liner top, a liner bottom, and a liner side wall, wherein the waste basket liner is a bag, wherein the waste basket liner is disposed on an inside of the waste basket, wherein the liner top wraps over a waste basket top terminating lip, wherein the waste basket liner covers the waste basket side wall inner surface and the waste basket false floor top surface.

In another aspect of the invention, the aperture is centrally disposed in the waste basket false floor. In another aspect of the invention, the aperture is disposed on and intersects an edge of the waste basket false floor. In another aspect of the invention, the aperture is disposed on and intersects a corner of the waste basket false floor.

In another aspect of the invention, the raised aperture wall comprises a curved wall in a cross-section therein. In another aspect of the invention, the raised aperture wall comprises a conical wall having a flat wall top at an upper opening. In another aspect of the invention, a lid is disposed on the waste basket.

In another aspect of the invention, a plurality of pliable waste basket liners is disposed in a series and wrapped around a waste basket liner roll, wherein the plurality of waste basket liners is sequentially attached to one another, wherein the waste basket liner roll is disposed on the inside of the waste basket beneath the waste basket false floor, wherein a first waste basket liner is inserted through and pulled through the aperture in the waste basket false floor from beneath, wherein the first waste basket liner is disposed on the inside of the waste basket, wherein the first liner top wraps over the waste basket top terminating lip, wherein the waste basket liner fully covers the waste basket side wall inner surface and the waste basket false floor top surface.

In another aspect of the invention, a side aperture is disposed in the waste basket side wall adjacent to the waste basket bottom, wherein a guiding ridge is disposed adjacent to the waste basket bottom on the waste basket side wall inner surface, wherein a drawer having an open drawer top and a planar drawer bottom is slidably inserted into the waste basket via the side aperture, wherein the drawer slides on the guiding ridge, wherein one or more waste basket liner rolls are disposed in the drawer.

### BRIEF DESCRIPTION OF THE DRAWINGS

FIG. 1 illustrates a perspective view of the present invention featuring the waste basket, the false floor, the aperture, and the trash bag.

FIG. 2 illustrates a perspective view of the present invention featuring the waste basket and the false floor, with the trash bag pulled up and retrieved from the trash bag refill drawer.

FIG. 3 illustrates a perspective view of the present invention featuring the waste basket with the trash bag fully retrieved and placed over the waste basket terminating top.

FIG. 4 illustrates a perspective view of the waste basket of the present invention featuring the waste basket and false floor with aperture, without any trash bag or trash bag refills.

FIG. 5 illustrates a perspective view of the present invention featuring the waste basket false floor partially removed and displaced, showing the ledge beneath the false floor.

FIG. 6 illustrates a perspective view of the present invention featuring the false floor and its aperture.

FIG. 7 illustrates a perspective view of the present invention featuring the bottom of the waste basket with the false floor and the trash bag refills drawer removed.

FIG. 8 illustrates a front view of the present invention featuring the waste basket with the trash bag storage drawer partially removed.

FIG. 9 illustrates a perspective view of the present invention featuring the waste basket, the trash bag storage drawer completely removed from the waste basket, and roles of trash bag refills in the trash bags storage drawer.

FIG. 10 illustrates a perspective view of the present inventions featuring the drawer and the trash bag refills.

FIG. 11 illustrates a perspective view of the present invention featuring the trash bag refill rolls with a trash bag pulled out.

FIG. 12 illustrates a front view of a box of trash bag rolls of the present invention.

FIG. 13 illustrates a perspective view of the present invention featuring the waste basket, the trash bag over the terminating top, and the lid covering the waste basket.

### DETAILED DESCRIPTION OF PREFERRED EMBODIMENTS

The present invention is an improved trash can having a base, a body, and a lid portion, and a trash bag storage drawer wherein trash bag refills can be stored and dispensed as needed. According to one embodiment of the present invention, a trash can system draws from a roll of trash bags in a supply container to replace a full bag. In another embodiment, a trash can system draws from a folded or inter-folded trash bags in a supply container to replace a full bag.

In one embodiment, the system comprises a trash can with a false floor wherein underneath the false floor is the storage drawer wherein trash bag refills are stored. The false floor is generally planar and has an aperture located therein. In some embodiments, a raised aperture wall is located on a waste basket false floor top surface and surrounds the aperture. In some embodiments, a raised lip surrounds a waste basket false floor outer periphery. In some embodiments, the waste basket false floor is placed on the inner ledge located on the waste basket side wall inner surface.

The false floor hides the trash bag refills and prevents the trash bag refills from being contaminated if there are any leaks from the trash bag in the trash can. The false floor also provides an aperture to allow one trash bag to be accessed and retrieved from the trash bag refills underneath the false floor in the storage drawer.

The aperture of the false floor further allows the full trash bag to be more easily placed into and removed from the trash can. This is because the trash stored in the bags tends to bulge against the wall of the trash can and air is often trapped between the bag and the trash can walls, thereby creating a vacuum effect that makes it difficult to remove the full trash bag. The aperture of the false floor allows the air to flow more freely in and out of the trash can, thereby removing the vacuum effect. As a result, this also allows a new trash bag to be more easily placed into the trash can, because the air between the trash can wall and the trash bag can escape through the aperture of the false floor.

In some embodiments, an inner ledge is located on a waste basket side wall inner surface thereon offset from and parallel to a waste basket bottom. The inner ledge provides support to the false floor and prevents the false floor from pushing down on the trash bag refills, which may be difficult to access and retrieve if the false floor is made immobile against the trash bag refills. When the trash bag is full, the full weight of the trash rests on the false floor. If there are not inner ledge to provide support, the false floor will be pressed down onto the trash bag refills. As a result, the trash bag refill drawer may be difficult to access with the weight of the trash anchoring it down. With the support of the inner ledge, however, the false floor will be able to support the weight of the trash without pressing down on the trash bag refill drawer or the trash bag refills, therefore, allow the trash bag refill drawer and the trash bag refills to be easily accessible even when the trash is full.

In some embodiments, the system comprises a pliable waste basket trash bag. In some embodiments, the waste basket trash bag is a bag. The bag can be drawn from a roll of trash bags in a supply container to replace a full bag. The bags can also be drawn from a folded or inter-folded trash bags in a supply container to replace a full bag.

In some embodiment, the system provides for an automatic trash bag refill system wherein when the full trash bag is removed from the waste basket, the full trash bag pulls on the next trash bag from the trash bag refill drawer. Therefore, when a full trash bag is removed for disposal, the next trash bag is automatically pulled up and retrieve for immediate use, eliminating the user from reaching down to pull on the next bag.

In some embodiments, the trash bag is located on an inside of the waste basket. In some embodiments, the trash bag top wraps over a waste basket top terminating lip. In some embodiments, the waste basket trash bag covers the waste basket side wall inner surface and the waste basket false floor top surface.

### DETAILED DESCRIPTIONS OF THE DRAWINGS

The following is a list of elements corresponding to a particular element of the present invention referred to herein:
100 Waste basket system
110 Waste basket
112 Waste basket top
113 Waste basket top terminating lip
114 Waste basket bottom
115 Waste basket bottom inner surface
116 Waste basket side wall
117 Waste basket side wall inner surface
118 Ledge
120 Waste basket false floor
121 Waste basket false floor top surface
122 Waste basket false floor outer periphery
125 Raised lip of the false floor
130 Aperture
132 Aperture wall
140 Waste basket trash bag
142 trash bag top
144 trash bag bottom
146 trash bag side wall
148 trash bag roll
150 Lid
160 Side aperture
162 Guiding ridge
170 Drawer
172 Drawer top
174 Drawer bottom

The present inventive waste basket is designed to eliminate many problems commonly incurred through the use of ordinary waste baskets.

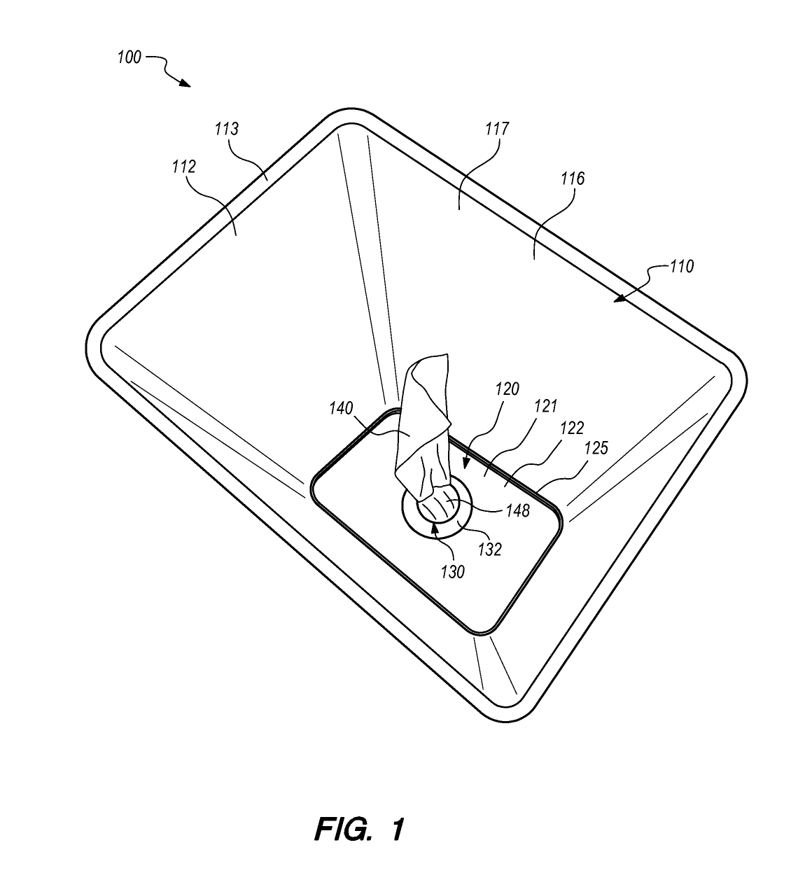

Referring to FIG. 1, the present invention features a waste basket system (100) for convenient internal storage of waste basket trash bags close to the point of use. The system (100) comprises a waste basket (110) having an open waste basket top (112) with a top terminating lip (113), waste basket side walls (116) with an inner surface (117), a waste basket false floor (120) with a top surface (121), outer periphery (122), and a raised lip (125). The false floor (120) contains an aperture (130) with aperture wall (132), wherein the trash bag (140) can be retrieved from the trash bag roll (148) in the drawer (not shown).

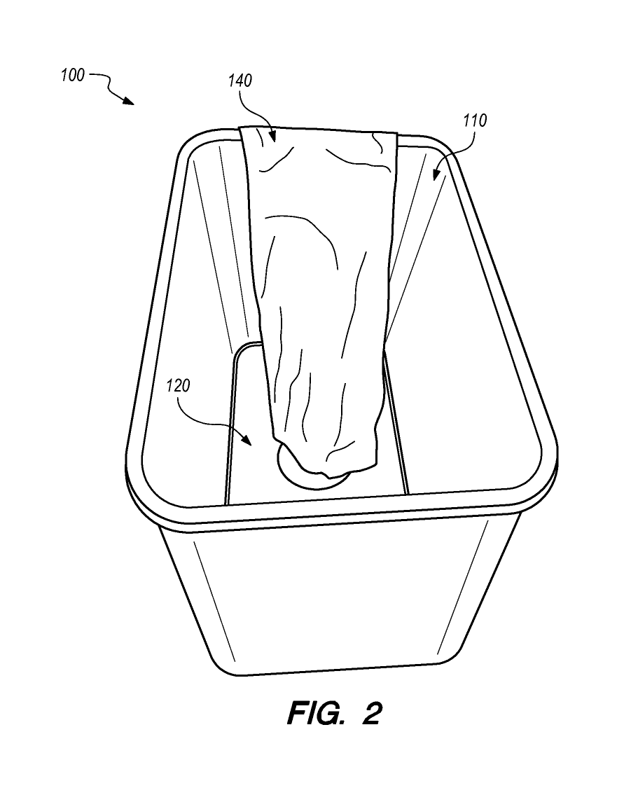

Referring to FIG. 2, the waste basket system (100) shows the waste basket (110) with false floor (120) and the trash bag (140) being pulled out. This illustrates the automatic trash bag (140) retrieval system, wherein when the full trash bag is removed from the waste basket (110) the next trash bag (140) is automatically pulled up as well for easy access by the user.

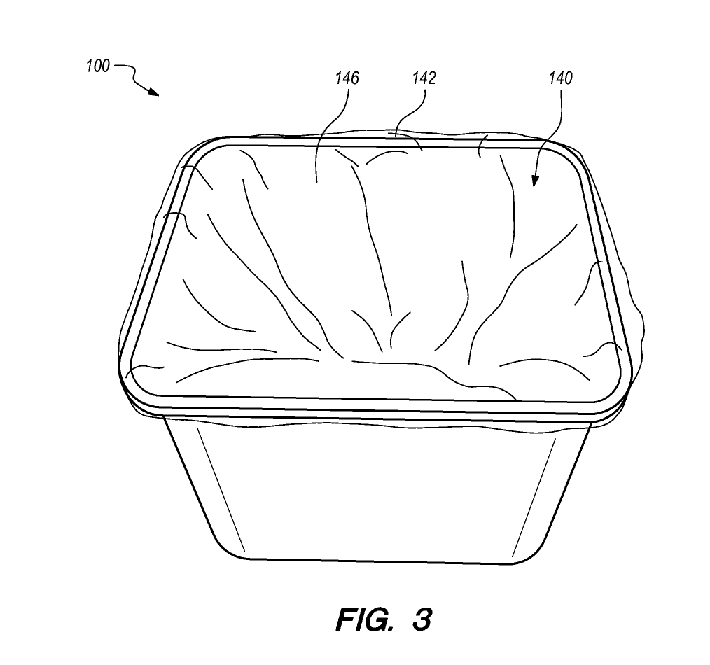

Referring to FIG. 3, the waste basket system (100) is shown wherein the trash bag (140) is pulled up with the trash bag top (142) wrapped over the waste basket top terminating lip (113) and the trash bag side wall (146) is against the waste basket side wall (116) against the inner surface (117). In some embodiments, the waste basket trash bag (140) covers the waste basket side wall inner surface (117) and the waste basket false floor top surface (121).

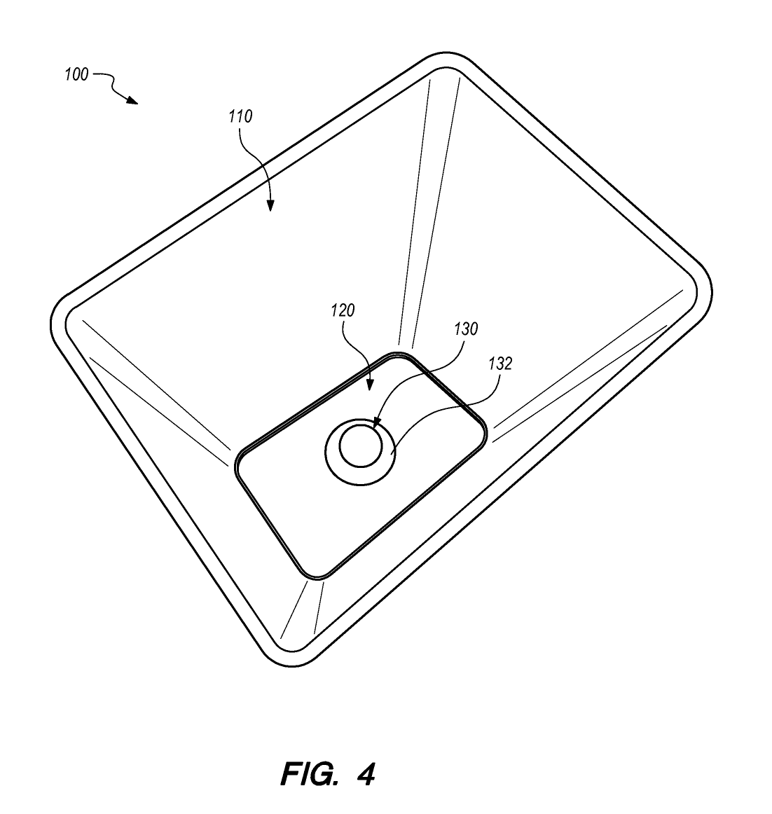

Referring to FIG. 4, the waste basket system (100) is shown with the waste basket (110) and the false floor (120) with the aperture (130) and aperture wall (132). The waste basket aperture (130) and aperture wall (132) allows for the false floor to be easily lifted and removed. This allows the waste basket system (100) to be easily cleaned or washed and dried. In some embodiments, the system (100) comprises a generally planar waste basket false floor (120) having an aperture (130) located therein. In some embodiments, the aperture (130) is round. In some embodiments, the aperture (130) is polygonal or irregularly shaped.

In some embodiments, a raised aperture wall (132) is located on a waste basket false floor top surface (121) and surrounds the aperture (130). In some embodiments, the raised aperture wall (132) is hemispherical (or has radial side walls). In some embodiments, a raised aperture wall (132) is sloped. In some embodiments, a raised aperture wall (132) is perpendicular to the waste basket false floor (120). In some embodiments, the aperture (130) is centrally located in the waste basket false floor (120). In some embodiments, the aperture (130) is located on and intersects an edge of the waste basket false floor (120). In some embodiments, the aperture (130) is located on and intersects a corner of the waste basket false floor (120).

In some embodiments, the raised aperture wall (132) comprises a curved wall in a cross-section therein. In some embodiments, the raised aperture wall (132) comprises a conical wall having a flat wall top at an upper opening.

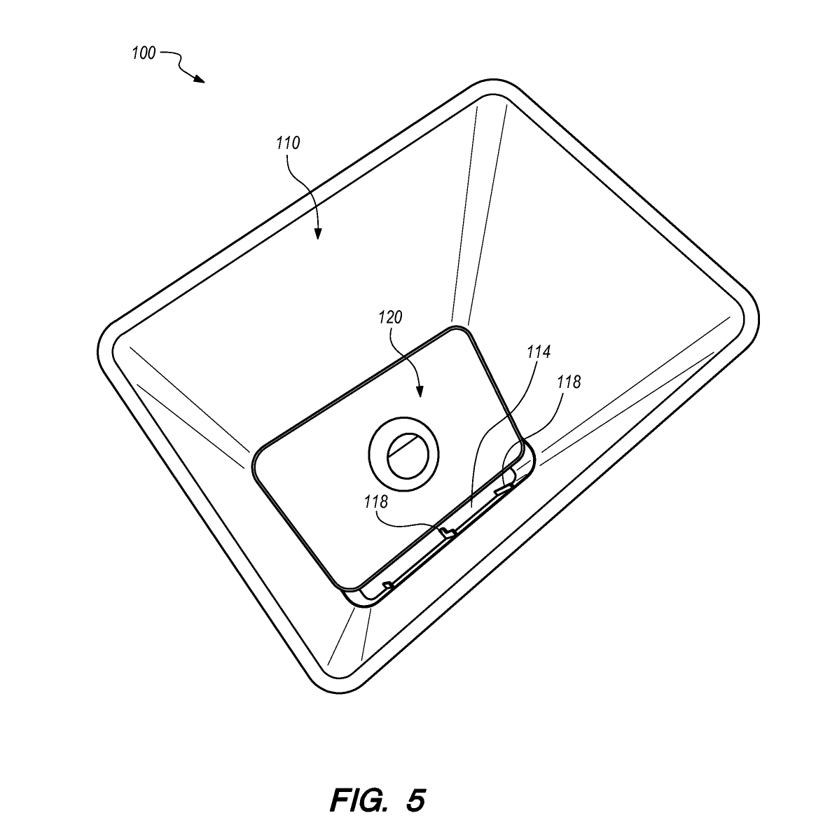

Referring to FIG. 5, the waste basket system (100) is shown with the waste basket (110) and the false floor (120). The false floor (120) is lifted and partially removed to show the waste basket bottom (114) and the inner ledge (118). The inner ledge (118) provides support to the false floor (120) to prevent it weighing on the drawer or the trash bags. In some embodiments, an inner ledge (118) is located on the waste basket side wall inner surface (117) thereon offset from and parallel to the waste basket bottom (114). In some embodiments, a plurality of inner ledges (118) is located around a periphery of the side wall inner surface (117). In some embodiments, one or more linear inner ledge(s) (118) are located around a periphery of the side wall inner surface (117) parallel to the waste basket bottom (114).

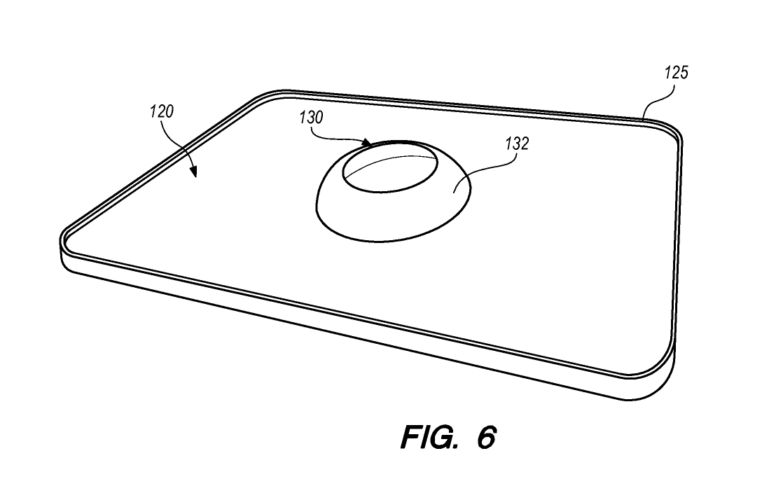

Referring to FIG. 6, a close-up of the false floor (120) is shown. The false floor (120) includes an aperture (130) with an aperture wall (132) and a raised lip (125). The false floor aperture (130) and aperture wall (132) provide easy access for the trash bags to be retrieved. They also allow the false floor (120) to be easily lifted and removed for cleaning. Finally, they allow air flow in and out of the waste basket, preventing vacuum from occurring. Thus allowing full trash bags to be easily removed and new trash bags to be easily placed into the waste basket (110).

In some embodiments, a raised lip (125) surrounds a waste basket false floor outer periphery (122). In some embodiments, the raised lip (125) and the raised aperture wall (132) keep debris and liquid that may have spilled onto the waste basket false floor (120) from running off the side edge of the waste basket false floor (120) or into the aperture (130).

In some embodiments, the raised aperture wall (132) and the raised lip (125) both project out and away from the waste basket false floor top surface (121). In some embodiments, the waste basket false floor (120) is removably located on the inner ledge (118) located on the waste basket side wall inner surface (117). In some embodiments, the waste basket false floor (120) snaps into place.

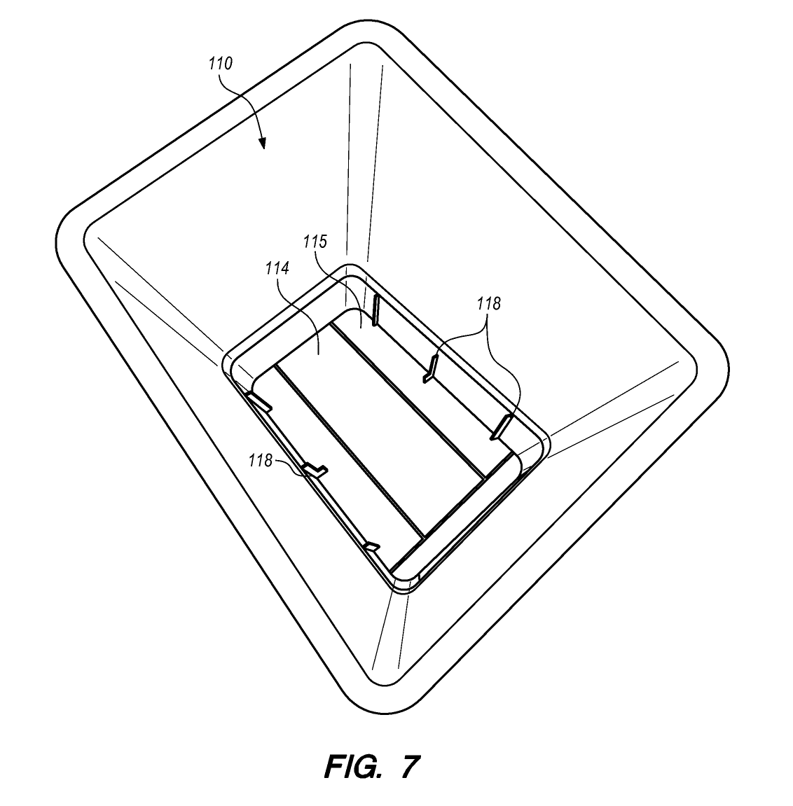

Referring to FIG. 7, a waste basket (110) is shown waste basket bottom (114) and inner surface (115). The ledge (118) as shown provide support to the false floor.

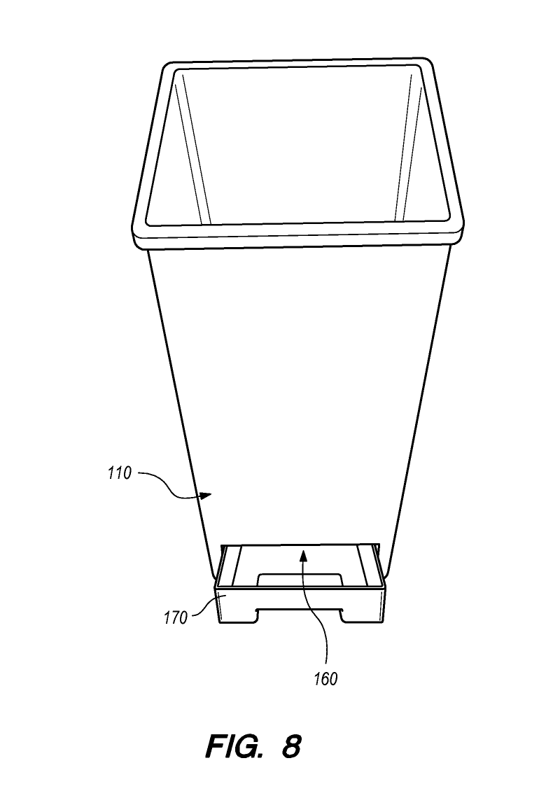

Referring to FIG. 8, a waste basket (110) is shown with a side aperture (160) and a drawer (170) that fits into the side aperture (160). The drawer (170) functions as a storage compartment for trash bags, and it can be completely removed for cleaning. The drawer (170) can be re-attached to the waste basket (110) through the side aperture (160).

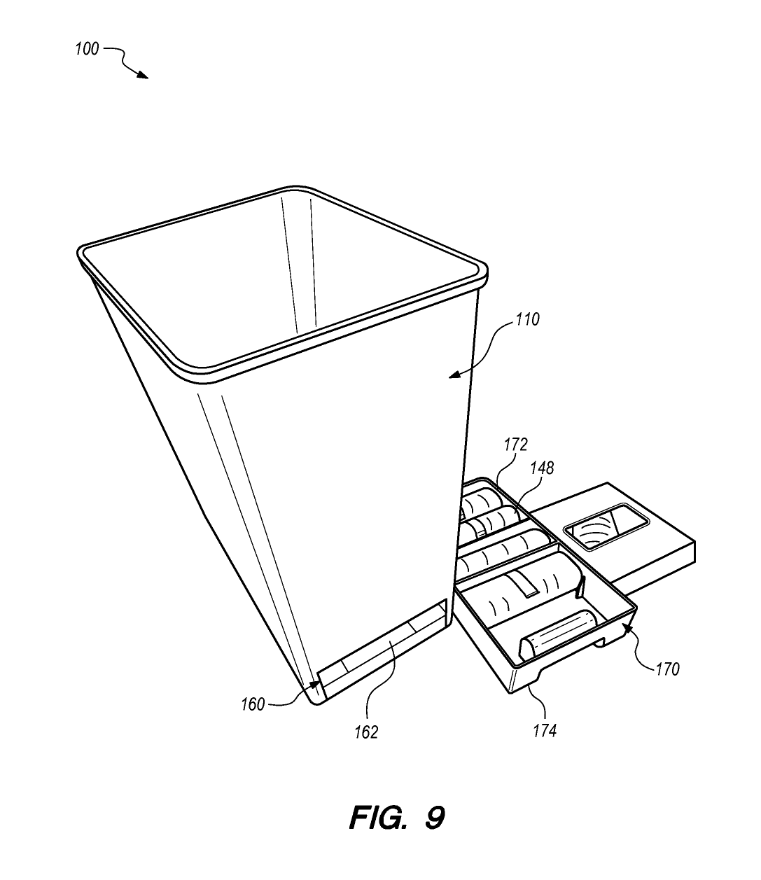

Referring to FIG. 9, the waste basket system (100) shows a waste basket (110) with a side aperture (160) and a guiding ridge (162). The drawer (170) with trash bag rolls (148) placed inside is shown, wherein the trash bag rolls (148) should not be over the drawer top (172) as to allow the drawer (170) to be re-attached to the waste basket (110) through the side aperture (160). Furthermore, the guiding ridge (162) on the waste basket bottom inner surface (117) guides the drawer bottom (174) so the drawer (170) slides in smoothly. In some embodiments, a guiding ridge (162) is located on the waste basket bottom (114) instead of on the waste basket side wall inner surface (117).

In some embodiments, a drawer (170) having an open drawer top (172) and a planar drawer bottom (174) is slidably inserted into the waste basket (110) via the side aperture (160). In some embodiments, the drawer (170) slides on or against the guiding ridge (162). In some embodiments, one or more waste basket trash bag rolls (146) are located in the drawer (170).

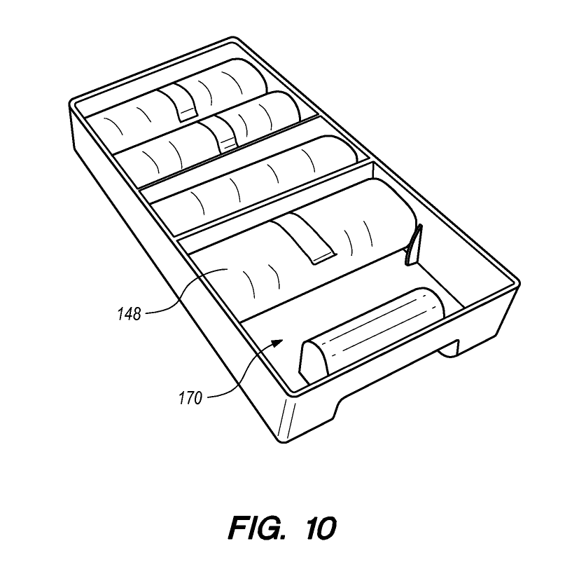

Referring to FIG. 10, a drawer (170) with trash bag rolls (148) is shown. A multiple of trash bag rolls (148) can be stored in the drawer (170).

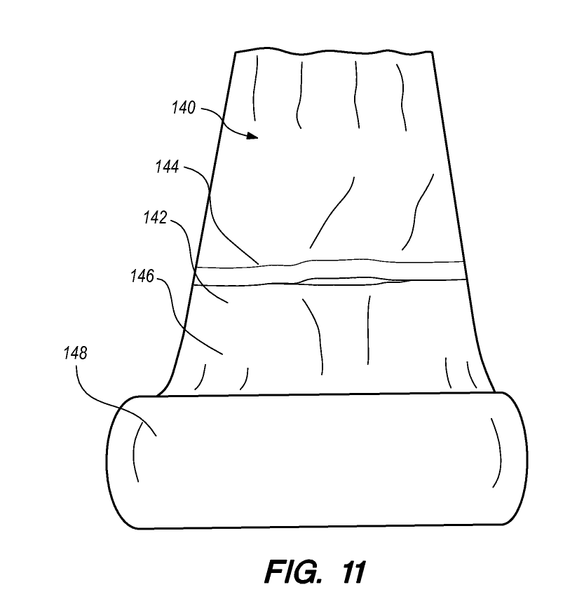

Referring to FIG. 11, a trash bag roll (148) with a trash bag (140) pulled out is shown. The trash bag top (142) must contain the opening of the trash bag (140), and the trash bag bottom (144) must connect the next trash bag (140) at the trash bag top (142). The trash bag side wall (146) can be expanded to line the waste basket wall (116) at the inner surface (117).

In some embodiments, when the first waste basket trash bag (140) is removed from the inside of the waste basket (110), a second, waste basket trash bag (140) is pulled through the aperture (130) in the waste basket false floor (120) from beneath.

In some embodiments, the second waste basket trash bag (140) is attached to the first waste basket trash bag (140) when the first waste basket trash bag (140) is inside of the waste basket (110). In some embodiments, the second waste basket trash bag (140) is attached to the first waste basket trash bag (140) when the first waste basket trash bag (140) is inside of the waste basket (110)

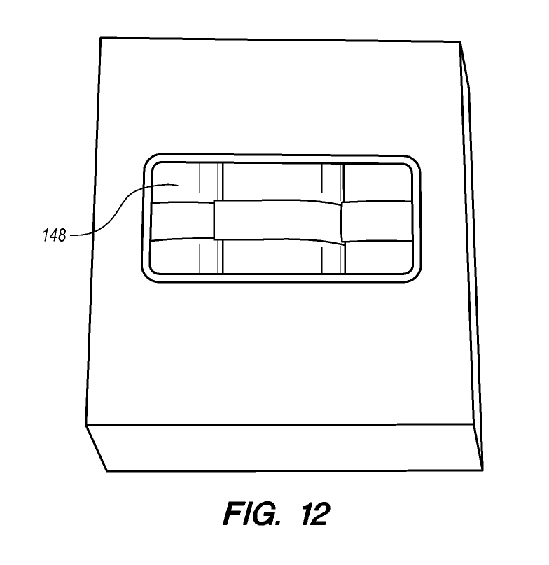

Referring to FIG. 12, a box of trash bag rolls (148) is shown.

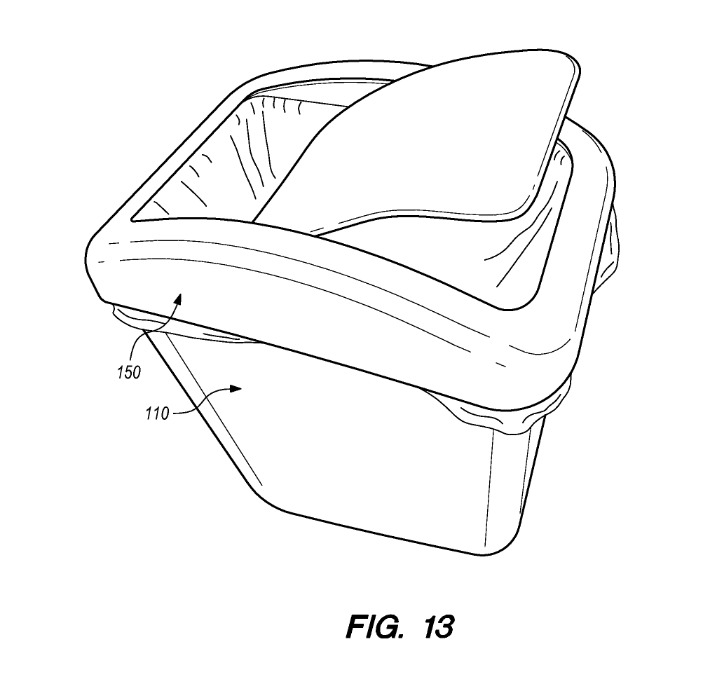

Referring to FIG. 13, a waste basket (110) with a lid (150) is shown, wherein the lid (150) is removable for easy cleaning or for taking out a full trash bag. The lid (150) also functions to cover unsightly trash and to prevent odor from emanating from the waste basket.

In some embodiments, the raised aperture wall (132) comprises a curved wall in a cross-section therein. In some embodiments, the raised aperture wall (132) comprises a conical wall having a flat wall top at an upper opening.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

1. A waste basket system (100) for convenient internal storage of waste basket liners proximal to a point of use, wherein the system (100) comprises:
(a) a waste basket (110) having an open waste basket top (112), a planar waste basket bottom (114) having a waste basket bottom inner surface (115), and a waste basket side wall (116) having a waste basket side wall inner surface (117), wherein an inner ledge (118) is disposed on the waste basket side wall inner surface (117) thereon offset from and parallel to the waste basket bottom (114);
(b) a generally planar waste basket false floor (120) having an aperture (130) disposed therein, wherein a raised aperture wall (132) is disposed on a waste basket false floor top surface (121) and surrounds the aperture (130), wherein a raised lip (125) surrounds a waste basket false floor outer periphery (122), wherein the raised aperture wall (132) and the raised lip (125) both project out and away from the waste basket false floor top surface (121), wherein the waste basket false floor (120) is removably disposed on the inner ledge (118) disposed on the waste basket side wall inner surface (117); and
(c) a pliable waste basket liner (140) having an open liner top (142), a liner bottom (144), and a liner side wall (146), wherein the waste basket liner (140) is a bag, wherein the waste basket liner (140) is disposed on an inside of the waste basket (110), wherein the liner top (142) wraps over a waste basket top terminating lip (113), wherein the waste basket liner (140) covers the waste basket side wall inner surface (117) and the waste basket false floor top surface (121).

2. The system (100) of claim 1, wherein the aperture (130) is centrally disposed in the waste basket false floor (120).

3. The system (100) of claim 1, wherein the aperture (130) is disposed on and intersects an edge of the waste basket false floor (120).

4. The system (100) of claim 1, wherein the aperture (130) is disposed on and intersects a corner of the waste basket false floor (120).

5. The system (100) of claim 1, wherein the raised aperture wall (132) comprises a curved wall in a cross-section therein.

6. The system (100) of claim 1, wherein the raised aperture wall (132) comprises a conical wall having a flat wall top at an upper opening.

7. The system (100) of claim 1, wherein a lid (150) is disposed on the waste basket (110).

8. The system (100) of claim 1, wherein a plurality of pliable waste basket liners (140) is disposed in a series and wrapped around a waste basket liner roll (148), wherein the plurality of waste basket liners (140) is sequentially attached to one another, wherein the waste basket liner roll (148) is disposed on the inside of the waste basket (110) beneath the waste basket false floor (120), wherein a first waste basket liner (140) is inserted through and pulled through the aperture (130) in the waste basket false floor (120) from beneath, wherein the first waste basket liner (140) is disposed on the inside of the waste basket (110), wherein the first liner top (142) wraps over the waste basket top terminating lip (113), wherein the waste basket liner (140) fully covers the waste basket side wall inner surface (117) and the waste basket false floor top surface (121).

9. The system (100) of claim 1, wherein a side aperture (160) is disposed in the waste basket side wall (116) adjacent to the waste basket bottom (114), wherein a guiding ridge (162) is disposed adjacent to the waste basket bottom (114) on the waste basket side wall inner surface (117), wherein a drawer (170) having an open drawer top (172) and a planar drawer bottom (174) is slidably inserted into the waste basket (110) via the side aperture (160), wherein the drawer (170) slides on the guiding ridge (162), wherein one or more waste basket liner rolls (146) are disposed in the drawer (170).
